(19) United States
(12) Patent Application Publication
(10) Pub. No.: US 2024/0415213 A1
(43) Pub. Date: Dec. 19, 2024

(54) TACTICAL GLOVE AND COMPASS

(71) Applicant: John Ronald Collins, Alexandria, VA (US)

(72) Inventor: John Ronald Collins, Alexandria, VA (US)

(21) Appl. No.: 18/336,481

(22) Filed: Jun. 16, 2023

(51) Int. Cl. A41D 19/00; G01C 17/24

(52) U.S. Cl. CPC A41D 19/0027; G01C 17/24

(57) ABSTRACT

A tactical glove-and-compass combination, including a tactical glove and a compass, is disclosed. The glove includes an exterior layer having an exterior surface and an interior surface. The exterior layer includes a stitched pattern between the exterior and interior surfaces. The glove includes fill material adjacent to the interior surface. The compass includes a body, a lens on the body, and an elongated tether on the body. The tether has opposite end portions, each being held between the exterior layer and the fill material.

### FIELD

While the prior art shows a variety of gloves to which a compass can be attached, the present subject matter is directed to the combination of a tactical glove and compass.

### BACKGROUND OF THE INVENTION

U.S. Pat. No. 1,309,150 to Monfort discloses an attachment for gloves or cuff gloves including a stud fixed to a glove or cuff, an elongated flap having a stud fixed to one end portion thereof, and a compass. The compass and the opposite end portion of the flap are together fixed to the glove or cuff by a bolt. The length of the flap is sufficient to enable a glove wearer to cover the compass with the flap and snap the socket and stud together.

U.S. Pat. No. 4,761,835 to Chen shows a glove to which a compass can be attached. U.S. Pat. No. 5,582,554 to Stryczek shows a golf glove to which a compass can be attached.

US 2005/0034212 to Eisenbraun; US 2006/0143784 to Jonker; US 2011/0138517 to Ambrosio et al., US 2011/0225703 to Maple et al.; US2018/0052004 to Friedlander; and US 2019/0216144 to York-all show examples of gloves to which a compass can be attached. U.S. Pat. No. 9,229,535 to Vice et al. discloses a haptic automated communication system (HACS) which is said to include an instrumented glove for hand signal recognition and weapon activity sensing. Also, the glove is described as including a digital compass.

According to a certain dictionary (Webster's New World Dictionary of the American Language, College Ed., copyright 1968, p. 1483), the word “tactical,” an adjective, means 1) of tactics, especially in military or naval maneuvers; 2) characterized by or showing cleverness and skill in tactics. According to the internet, the word “tactical” has evolved to now currently mean: “of or relating to tactics, which are specific plans or maneuvers to achieve a goal in war or politics.” Tactical can also describe weapons, attacks, or forces used or occurring battlefronts. The word stems from a Greek term for “art of arrangement.”

Notwithstanding the preceding paragraph (involving definitions) the word “tactical,” throughout this patent specification, shall be understood to relate to Military, First Responder, Security, Law Enforcement professionals, hunters, and/or Airsoft players in relation to the present subject matter.

Accordingly, Military, First Responders, Security, Law Enforcement professionals, hunters, and Airsoft players shall greatly appreciate wearing such gloves when directional information is essential to have.

### SUMMARY OF THE INVENTION

The present subject matter, directed to a tactical glove-and-compass combination, includes a tactical glove and a compass. The glove includes an exterior layer defining an exterior surface and an interior surface. The exterior layer includes a strength-providing stitched pattern between the exterior and interior surfaces. The tactical glove includes a preselected fill material adjacent to the interior surface. The compass includes a compass body, a lens on the body, and an elongated tether on the body. The tether has spaced-apart end portions, each of which is held between the exterior layer and the fill material.

### BRIEF DESCRIPTION OF THE DRAWINGS

FIG. 1 presents a perspective view of an embodiment of the present subject matter.

FIG. 2 is an enlarged view of a part of the illustrated embodiment shown in FIG. 1.

FIG. 3 is a sectional view from the plane 3-3 of the embodiment shown in FIG. 1.

### DETAILED DESCRIPTION OF THE INVENTION

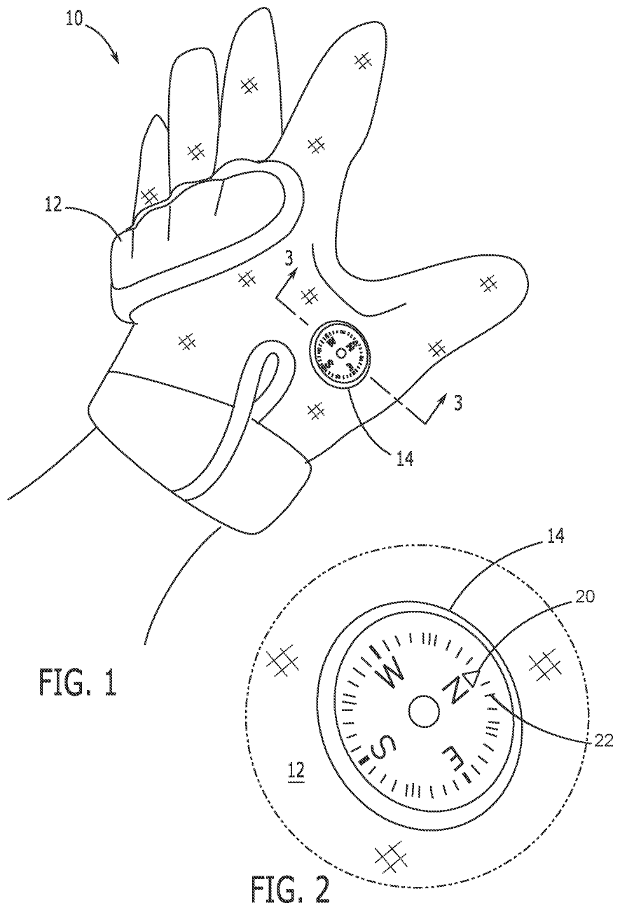

A tactical glove-and-compass combination 10 (please see FIG. 1), in accordance with the present subject matter, includes a tactical glove 12 and a compass 14. (FIG. 2.) Although the position of the compass is not particularly limited, the compass may be positioned on the glove over the metacarpal I bone or between the metacarpal I and metacarpal II bones of the hand for ready visibility, as shown in FIG. 1.

The glove 12 includes an exterior layer 12A having an exterior surface 13 and an interior surface 15. The exterior layer 12A can be made of a suitable fire-retardant material including but not limited to aramid (para and meta), modacrylic, melamine, carbon foam, coated nylon, flame retardant cotton, and PBI (a common abbreviation for poly [2,2′-(m-phenylene)-5,5′-bisbenzimidazole]) fiber, a synthetic fiber having a very high decomposition temperature.

The exterior layer 12A of the tactical glove 12 includes a strength-enhancing and/or strength-providing stitched pattern 18 between the exterior and interior surfaces 13, 15.

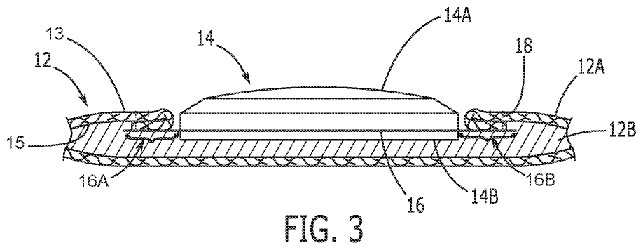

The tactical glove 12 may or may not also include a preselected filler material 12B (FIG. 3) closely adjacent or abutting the interior surface 15 of the exterior layer 12A. For the fire-fighting first responder professionals, the filler material 12B is a suitable fire-retardant material. For security and law enforcement professionals, filler material 12B is a suitable puncture- and/or bullet-proof material including but not limited to aramid (para and meta) based fiber. The compass 14, which is preferably no more than about 25.4 millimeters (1 inch) in diameter, includes a compass body 14B, a compass lens 14A on the body 14B, and an elongated tether 16. The elongated tether 16, removably secured (preferably fixed) to the body 14B, includes spaced-apart opposite end portions 16A and 16B, each of which is itself secured to the tactical glove between the exterior layer 12A and the fill material 12B. Thus the compass 14 is embedded within the glove 12 rather than affixed atop the exterior layer 12A.

The compass 14 could be manufactured to be readable at night by coating the directional letters “N”, “E”, “S,” “W” and the pointer 20, and possibly preferably most or all the directional lines 22 (see FIG. 3), with suitable fluorescent or phosphorescent material per standard industry practice for handheld or wrist-mounted compasses produced by such companies as Suunto®.

Fluorescence is the emission of light by a substance that has absorbed light or other electromagnetic radiation. It is a form of luminescence. In most cases, the emitted light has a longer wavelength, and therefore a lower photon energy, than the absorbed radiation. A perceptible example of fluorescence occurs when the absorbed radiation is in the ultraviolet (“UV”) region of the electromagnetic spectrum (i.e., invisible to the human eye), while the emitted light is in the visible region; this gives the fluorescent substance a distinct color that can only be seen after the substance has been exposed to the UV light. In operation, fluorescent materials cease glowing immediately after a radiation source stops, unlike phosphorescent materials, which continue to emit light for some time after.

Phosphorescence is a type of photoluminescence related to fluorescence. When exposed to light (radiation) of a shorter wavelength, a phosphorescent substance will glow, absorbing the light and re-emitting it at a longer wavelength. Unlike fluorescence, a phosphorescent material does not immediately re-emit the radiation it absorbs. Instead, a phosphorescent material absorbs some of the radiation energy and re-emits it for a much longer time after the radiation source is removed. In a general sense, there is no distinct boundary between the emission times of fluorescence and phosphorescence (i.e.: if a substance glows under a black light it is generally considered fluorescent, and if it glows in the dark it is often simply called phosphorescent). In a modern, scientific sense, the phenomena can usually be classified by the three different mechanisms that produce the light, and the typical timescales during which those mechanisms emit light. Whereas fluorescent materials stop emitting light within nanoseconds (billionths of a second) after the excitation radiation is removed, phosphorescent materials may continue to emit an afterglow ranging from a few microseconds to many hours after the excitation is removed.

Described in this patent specification is a tactical glove and compass combination. While the present subject matter has been described with connection with an exemplary embodiment, the present subject matter is not limited to this embodiment. On the contrary, alternatives, changes, and modifications shall become apparent to a person of ordinary skill in the art (“POSITA”) after this patent specification is reviewed. Therefore, all alternatives, changes, and modifications are to be treated as forming a part of the present subject matter insofar as they fall within the spirit and the scope of the appended claims.

What is claimed is:

1. A tactical glove-and-compass combination (10), comprising:
a tactical glove (12),
wherein the glove (12) comprises:
an exterior layer (12A) defining an exterior surface (13) and an interior surface (15), wherein the exterior layer (12A) includes a strength-providing stitched pattern (18) between the exterior surface and the interior surface (15); and
a fill material (12B) adjacent to the interior surface (15); and
a compass (14),
wherein the compass (14) comprises:
a compass body (14B);
a compass lens (14A) located on the body (14B); and
an elongated tether (16) located on the body (14B), wherein the tether (16) defines a pair of spaced-apart opposite end portions (16A, 16B), and wherein each of the end portions (16A, 16B) is separately secured between the exterior layer (12A) and the fill material (12B).

2. The tactical glove-and-compass combination (10) of claim 1, wherein the compass (14) is no more than about 25.4 millimeters in diameter.

3. The tactical glove-and-compass combination (10) of claim 1, wherein the compass (14) is readable at night.
